(19) United States
(12) Patent Application Publication
(10) Pub. No.: US 2026/0208522 A1
(43) Pub. Date: Jul. 23, 2026

(54) SECURITY ELEMENT HAVING A COLOR-SHIFTING THIN-FILM STRUCTURE

(71) Applicant: GIESECKE+DEVRIENT CURRENCY TECHNOLOGY GMBH, Munchen (DE)

(72) Inventors: Josef SCHINABECK, Kreuth (DE); Maik Rudolf Johann SCHERER, Grainau (DE); Giselher DORFF, Holzkirchen (DE)

(21) Appl. No.: 19/157,116

(22) PCT Filed: Feb. 5, 2024
(86) PCT No.: PCT/DE2024/100089

§ 371 Date: Aug. 15, 2025

(30) Foreign Application Priority Data
Feb. 15, 2023 (DE) 10 2023 103 669.6

(51) Int. Cl. B42D 25/373; B42D 25/328; B42D 25/465

(52) U.S. Cl. CPC B42D 25/373; B42D 25/328; B42D 25/465

(57) ABSTRACT

A security element for securing value documents that features a color-shifting thin-film structure includes an absorber layer, a reflection layer, and a dielectric spacing layer positioned between them. An ultra-thin adhesion-promoter layer, with a thickness between 1 nm and 10 nm, is also placed between the dielectric spacing layer and the reflection layer.

The present invention relates to a security element for securing value documents, having a color-shifting thin-film structure that comprises an absorber layer, a reflection layer and a dielectric spacing layer arranged between the absorber layer and the reflection layer.

For protection, data carriers, such as value or identification documents, but also other valuable objects, such as branded articles, are often furnished with security elements that permit the authenticity of the data carriers to be verified and that simultaneously serve as protection against unauthorized reproduction. The security elements can be developed, for example, in the form of a security thread embedded in a banknote, a cover foil for a banknote having a hole, an applied security strip, a self-supporting transfer element, or also in the form of a feature region imprinted directly on a value document.

Security elements having a viewing-angle-dependent appearance play a special role in safeguarding authenticity, as these cannot be reproduced even with the most modern copiers. For this, the security elements are furnished with optically variable elements that, from different viewing angles, convey to the viewer a different image impression and for example display a different color or brightness impression and/or a different graphic motif depending on the viewing angle.

For this purpose, security elements having multilayer thin-film elements whose color impression changes for the viewer with the viewing angle (referred to below as a color-shift effect) are often used. In such thin-film elements, the color-shift effect is based on viewing-angle-dependent interference effects due to multiple reflections in the different sub-layers of the element. The path difference of the light reflected at the different layers depends, on one hand, on the optical thickness of a dielectric spacing layer that determines the distance between a semitransparent absorber layer and a reflection layer, and on the other hand, it varies with the respective viewing angle. Since the path difference is on the order of magnitude of the wavelength of visible light, an angle-dependent color impression results for the viewer due to destructive interference and amplification of certain wavelengths. Through a suitable choice of material and thickness of the layers participating in the interference effect, a plurality of different color shift effects can be produced.

However, known thin-film elements having a layer sequence composed of absorber layer, dielectric spacing layer and reflection layer tend to have a high splitting tendency depending on the thickness of the dielectric spacing layer and also depending on any embossing lacquer that may be used arranged under the layer sequence of the thin-film element. In particular, problems can occur in the manufacture, but particularly also in the circulation stability, of the security elements furnished with the thin-film structures due to too-low adhesion of the reflection layer material to the dielectric spacing layer.

Proceeding from this, the object of the present invention is to specify a security element of the kind cited above having improved splitting protection and high circulation stability.

Said object is solved by the features of the independent claims. Developments of the present invention are the subject of the dependent claims.

According to the present invention, in a generic security element, it is provided that there is arranged between the dielectric spacing layer and the reflection layer an ultra-thin adhesion-promoter layer having a thickness between 1 nm and 10 nm. The inventors have surprisingly found that the adhesion between the dielectric spacing layer and the reflection layer is significantly improved by such an additional adhesion-promoter layer, especially a chrome layer or a titanium layer, and the problems associated with the splitting tendency of conventional three-layer structures can be overcome. At the same time, an ultra-thin adhesion-promoter layer in the thickness range mentioned has only a minor influence on the color effect and the color-shift effect of the thin-film structure. If necessary, this minor influence can be compensated by an adaptation of the layer thickness of the dielectric spacing layer.

In one preferred embodiment, the absorber layer is formed by a chrome layer that advantageously comprises a layer thickness between 2 nm and 10 nm, for example of about 6 nm.

The reflection layer is advantageously formed by an aluminum layer, especially by an opaque aluminum layer. The aluminum layer can comprise a layer thickness between 5 nm and 200 nm, especially between 30 nm and 100 nm.

The dielectric spacing layer is advantageously formed by an SiO₂ layer. Here, the layer thickness of the dielectric spacing layer is chosen such that a desired color-shift effect, that is, a first color impression when viewed vertically and a second, different color impression when viewed obliquely, is achieved.

The ultra-thin adhesion-promoter layer is advantageously formed by a chrome layer or a titanium layer, preferably by a chrome or titanium layer of a thickness between 1 nm and 4 nm. Currently, the use of chrome for the adhesion-promoter layer is particularly preferred.

A layer thickness of the ultra-thin chrome or titanium layer of 3 nm has proven to be particularly advantageous.

In one preferred design, the color-shifting thin-film structure constitutes a four-layer structure that includes, in this order, an absorber layer composed of chrome, a dielectric spacing layer composed of SiO₂, the said ultra-thin chrome layer and a reflection layer composed of aluminum.

In one advantageous development of the present invention, the color-shifting thin-film structure is applied on an embossing lacquer layer furnished with a relief structure.

Here, the relief structure is advantageously a diffractive structure, especially a hologram, a holographic grating image or a hologram-like diffraction structure, an achromatic structure, especially a matte structure, or a micromirror arrangement or a blazed grating having a sawtooth-like groove profile or a Fresnel lens arrangement, or is formed by a combination of two or more of the said structures.

The security element is preferably a security thread, a security strip, a patch or a label.

The present invention also includes a data carrier, especially a value document, having a security element of the kind described. The data carrier can especially be a value document, such as a banknote, especially a paper banknote, a polymer banknote or a foil composite banknote, a stock, a bond, a certificate, a voucher, a check, a valuable admission ticket, but also an identification card, such as a credit card, a bank card, a cash card, an authorization card, a personal identity card or a passport personalization page. The security element can especially be arranged in a window region of the data carrier.

The present invention further includes a method for manufacturing a security element of the kind described, in which an absorber layer, a dielectric spacing layer and a reflection layer are applied to a substrate, and in which an ultra-thin adhesion-promoter layer having a thickness between 1 nm and 10 nm is applied, especially sputtered on, between the dielectric spacing layer and the reflection layer.

The substrate can especially be formed by a carrier foil or by an already coated, for example furnished with an embossed embossing lacquer layer, carrier foil.

Further exemplary embodiments and advantages of the present invention are explained below by reference to the drawings, in which a depiction to scale and proportion was dispensed with in order to improve their clarity.

Shown are:

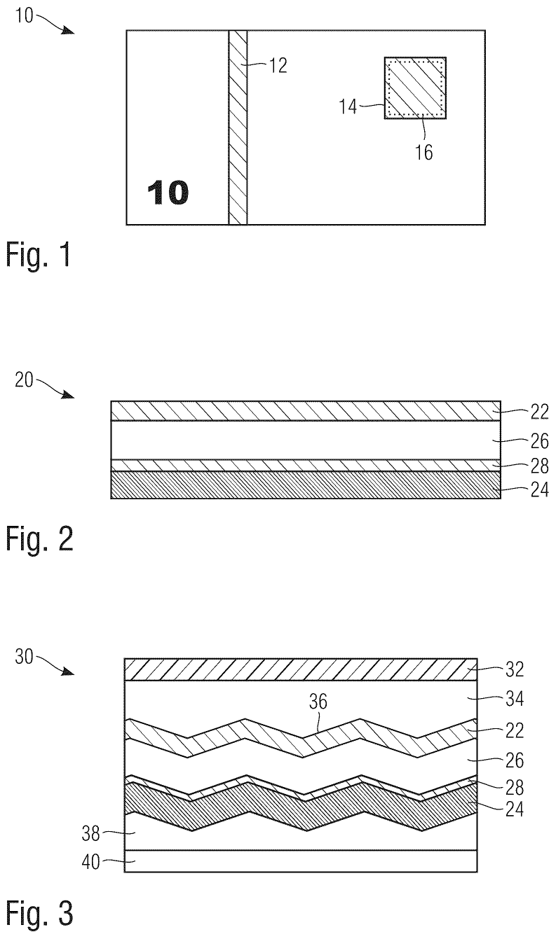

FIG. 1 a schematic diagram of a banknote having two security elements according to the present invention,

FIG. 2 a security element according to an exemplary embodiment of the present invention, in cross section, and

FIG. 3 a security element according to a further exemplary embodiment of the present invention, in which a color-shifting thin-film structure is combined with a relief structure.

The invention will now be explained using the example of security elements for banknotes. For this, FIG. 1 shows a schematic diagram of a banknote 10 that is furnished with two inventive security elements 12 and 14. The first security element constitutes a security thread 12 that is applied on the surface of the banknote. The security thread can, of course, also be formed by a window security thread that emerges at certain window regions on the surface of the banknote, while it is embedded in the interior of the banknote in the regions lying therebetween.

The second security element is formed by an affixed transfer element 14, of any shape, that is arranged in a window region 16 of the banknote 10 and there covers, for example, a through opening in the banknote. However, the transfer element can also be arranged over an opaque or translucent material region of the banknote.

The special structure of security elements according to the present invention, for instance of the security thread 12 or of the transfer element 14, will now be explained in greater detail with reference to FIG. 2, which shows, schematically in cross section, a security element 20 according to the present invention.

The security element 20 includes a four-layer color-shifting thin-film structure having an absorber layer 22 composed of chrome, a reflection layer 24 composed of aluminum and, arranged between the absorber layer 22 and the reflection layer 24, a dielectric spacing layer 26 composed of SiO₂. As a distinctive feature, for adhesion improvement, an ultra-thin chrome layer 28 having a thickness between 1 nm and 10 nm, especially between 1 nm and 4 nm, is arranged between the dielectric spacing layer 26 and the reflection layer 24, such that in total a four-layer structure is created.

It has surprisingly been shown that through such an additional ultra-thin chrome layer 28, the adhesion between the spacing layer 26 and the reflection layer 24 can be significantly improved and the problems associated with the splitting tendency of conventional three-layer structures can be reduced or even completely overcome.

Here, a layer thickness of the ultra-thin chrome layer 28 of about 3 nm has proven to be particularly effective.

Due to the presence of the additional, to a certain extent light-absorbing, chrome layer 28, the color effect of the original layer sequence composed of absorber 24, dielectric 26 and reflector 28 does shift slightly, but said shift can, if desired, easily be compensated by adjusting the layer thickness of the dielectric spacing layer 26. As a result, a thin-film structure according to the present invention having the same color effect as a conventional thin-film structure can be provided, albeit with significantly improved splitting protection.

It is understood that, depending on the application, the basic layer structure in FIG. 2 can be supplemented by further, per se known layers, such as a protective layer, an adhesive layer or an embossing lacquer layer. Instead of an ultra-thin chrome layer, also an ultra-thin titanium layer can be used for adhesion improvement.

FIG. 3 shows a security element 30 according to a further exemplary embodiment of the present invention, in which the color-shifting thin-film structure is combined with a relief structure, such as a micromirror arrangement.

The security element 30 includes a carrier foil 32, for example a transparent, colorless PET foil, to which an embossing lacquer layer 34 was applied and furnished with a relief embossing 36. The relief embossing 36 can constitute, for example, a micromirror arrangement to produce a desired optical effect.

To the embossed embossing lacquer layer 34 were then applied, as already described in principle for FIG. 2, an absorber layer 22 composed of chrome, a dielectric spacing layer 26 composed of SiO₂, an ultra-thin chrome layer 28 having a thickness between 1 nm and 10 nm, especially between 1 nm and 4 nm, and a reflection layer 24 composed of aluminum. Further, a leveling lacquer layer 38 and further layers 40 are provided, for example a primer layer and an adhesive layer for applying the security element to a target substrate. After the application of the security element to the target substrate, the carrier foil 32 can be removed, or alternatively, can also remain in the layer structure. In the former case, additionally, a release layer that facilitates the detachment of the carrier foil can be provided between the carrier foil 32 and the embossing lacquer layer 34.

The security element 30 in FIG. 3 is configured for viewing from the side of the carrier foil 32, since from this viewing direction, the reflection layer 24 constitutes the thin-film structure layer that is furthest from the viewer. If the viewing is to occur from the opposite side of the security element, the layers of the thin-film structure can also be applied on the embossing lacquer layer 34 in the reverse order, that is, in the order reflection layer 24, adhesion-improving ultra-thin chrome layer 28, dielectric spacing layer 26 and absorber layer 22. The leveling lacquer layer 38 and further layers 40 are then applied to the absorber layer 22.

Also in this embodiment, instead of an ultra-thin chrome layer, an ultra-thin titanium layer can be used for adhesion improvement.

### REFERENCE SIGNS

10 Banknote
12 Security thread
14 Transfer element
16 Window region
20 Security element
22 Absorber layer
24 Reflection layer
26 Dielectric spacing layer
28 Ultra-thin chrome layer
30 Security element
32 Carrier foil
34 Embossing lacquer layer
36 Relief embossing
38 Leveling lacquer layer
40 Further layers

1.-11. (canceled)

12. A security element for securing value documents, having a color-shifting thin-film structure that comprises an absorber layer, a reflection layer and a dielectric spacing layer arranged between the absorber layer and the reflection layer,
wherein an ultra-thin adhesion-promoter layer having a thickness between 1 nm and 10 nm is arranged between the dielectric spacing layer and the reflection layer.

13. The security element according to claim 12, wherein the absorber layer is formed by a chrome layer.

14. The security element according to claim 12, wherein the reflection layer is formed by an aluminum layer.

15. The security element according to claim 12, wherein the dielectric spacing layer is formed by an SiO2 layer.

16. The security element according to claim 12, wherein the ultra-thin adhesion-promoter layer is formed by a chrome layer or a titanium layer, preferably by a chrome or titanium layer of a thickness between 1 nm and 4 nm.

17. The security element according to claim 16, wherein the ultra-thin chrome or titanium layer comprises a thickness of 3 nm.

18. The security element according to claim 12, wherein the color-shifting thin-film structure is applied on an embossing lacquer layer furnished with a relief structure.

19. The security element according to claim 18, wherein the relief structure forms a diffractive structure, especially a hologram, a holographic grating image or a hologram-like diffraction structure, an achromatic structure, especially a matte structure, a micromirror arrangement, a blazed grating having a sawtooth-like groove profile or a Fresnel lens arrangement, or a combination of two or more of the said structures.

20. The security element according to claim 12, wherein the security element is a security thread, a security strip, a patch or a label.

21. A data carrier, especially a value document, having a security element according to claim 12.

22. A method for manufacturing a security element according to claim 12, in which an absorber layer, a dielectric spacing layer and a reflection layer are applied to a substrate, and in which an ultra-thin adhesion-promoter layer having a thickness between 1 nm and 10 nm is applied, especially sputtered on, between the dielectric spacing layer and the reflection layer.
